(19) United States
(12) Patent Application Publication
(10) Pub. No.: US 2009/0033888 A1
(43) Pub. Date: Feb. 5, 2009

(54) Projecting Apparatus

(75) Inventors: Hirotake Nozaki, Port Washington, NY (US); Nobuhiro Fujinawa, Yokohama-shi (JP); Akira Ohmura, Tokyo (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 11/991,566

(22) PCT Filed: Sep. 12, 2006
(86) PCT No.: PCT/JP2006/318059

§ 371 Date: Apr. 7, 2008

(30) Foreign Application Priority Data
Sep. 12, 2005 (JP) 2005-263661

(51) Int. Cl. G03B 21/14

(52) U.S. Cl. 353/119; 353/122; 353/121

(57) ABSTRACT

A projecting apparatus includes: a projection unit that projects an image formed by an optical image formation element; an attitude detection device that detects an attitude of the projection unit, and outputs a detection signal; and a rotation device that rotates a projected image that is projected from the projection unit, according to a detection signal from the attitude detection device.

### TECHNICAL FIELD

The present invention relates to a projecting apparatus that projects an optical image.

### BACKGROUND OF THE INVENTION

An electronic device consisting of a compact device such as a portable telephone device or the like that is endowed with a function of projection is known (refer to Patent Document #1). With a portable telephone device with incorporated projector as described in Patent Document #1, while a person is conversing upon the telephone, he is enabled to project information upon his own hand: and he is also enabled to project information upon a wall surface while conversing on the telephone.

Patent Document #1: Japanese Laid-Open Patent Publication 2000-236375.

### DISCLOSURE OF THE INVENTION

### Problems to be Solved by the Invention

In Patent Document #1, there is no description of the relationship between the attitude of the electronic device and the orientation of the projected image (for example, vertically oriented, horizontally oriented, upside down, or the like).

### Means for Solving the Problems

A projecting apparatus according to a first aspect of the present invention includes: a projection unit that projects an image formed by an optical image formation element; an attitude detection device that detects an attitude of the projection unit, and outputs a detection signal; and a rotation device that rotates a projected image that is projected from the projection unit, according to a detection signal from the attitude detection device.

In the projecting apparatus according to the first aspect, it is preferable that the rotation device rotates an image to be formed by the optical image formation element according to the detection signal from the attitude detection device. The rotation device may rotate the optical image formation element according to the detection signal from the attitude detection device.

In the projecting apparatus according to the first aspect, it is preferable that an actuation member that is actuated in order to command rotation of the projected image is further provided and that the rotation device changes over between rotating the projected image, and not rotating the projected image, according to a command from the actuation member.

In the projecting apparatus according to the first aspect, it is preferable that the optical image formation element has an effective picture element region of approximately square shape. It is preferable that the optical image formation element makes a long side of an image of rectangular shape correspond to one side of the projected image, and generates an image by appending information in a blank margin that is formed in a short side direction of the image. It is preferable that the optical image formation element is a liquid crystal panel. It is preferable that the projected image to be projected from the projection unit is projected at a same size, even after rotation by the rotation device.

For the projecting apparatus according to the first aspect, it is preferable to further include: a first chassis that contains the projection unit; a second chassis that is different from the first chassis; and a rotation support member that rotatably supports the first chassis and the second chassis; and it is preferable that the projection unit projects in a plane that is orthogonal to a rotational axis of the rotation support member; and the attitude detection device detects an attitude of the first chassis. The attitude detection device may detect a relative angle between the first chassis and the second chassis when the second chassis has been rotated relative to the first chassis, as the attitude of the first chassis; and the rotation device may cause the projected image to be rotated through a same angle as the relative angle.

The projecting apparatus according to the first aspect may further include: a control unit that controls a projection operation executed by the projection unit; and a rotation support member that supports the projection unit and the control unit rotatably relative to one another; and the attitude detection device may detect a relative angle of the projection unit with respect to the control unit.

In a control method, according to a second aspect of the present invention, for a projecting apparatus comprising a projection unit that projects an image formed by an optical image formation element, an attitude of the projection unit is detected; and the image projected through the projection unit is rotated according to the attitude of the projection unit that has been detected.

### ADVANTAGEOUS EFFECT OF THE INVENTION

With the projecting apparatus according to the present invention, a projected image of the same orientation is obtained even if the attitude of the projection unit changes.

### BRIEF DESCRIPTION OF THE DRAWINGS

FIGS. 1(a) through 1(c) are views from three sides of a projector according to a first embodiment of the present invention: FIG. 1(a) is a left side view, FIG. 1(b) is a plan view, and FIG. 1(c) is a front view;

FIG. 2(a) is a figure in which this projector has been rotated through a relative angle θ=90°, FIG. 2(b) is a figure in which it has been rotated through a relative angle θ=180°, and FIG. 2(c) is a figure in which it has been rotated through a relative angle θ=270°.

FIG. 3 is a block diagram for explanation of a circuit structure of this projector;

FIG. 4 is a flow chart for explanation of the main processing flow performed by a CPU;

FIG. 5(a) is a figure showing an example of a projected image in the case of a landscape format image, and FIG. 5(b) is a figure showing an example of a projected image in the case of a portrait format image;

FIGS. 6(a) through 6(c) are views from three sides of a projector according to a second embodiment of the present invention: FIG. 6(a) is a left side view, FIG. 6(b) is a plan view, and FIG. 6(c) is a front view;

FIG. 7(a) is a left side view when this projector is mounted horizontally, and FIG. 7(b) is a front view when it is mounted horizontally;

FIG. 8(a) is a left side view when this projector is mounted vertically, and FIG. 8(b) is a front view when it is mounted vertically;

FIG. 9 is a figure for explanation of a projection module that rotates; and

FIG. 10 is a flow chart for explanation of determination processing for a battery mark.

### BEST MODES FOR CARRYING OUT THE INVENTION

Preferred embodiments for implementation of the present invention will now be explained in the following with reference to the drawings.

### First Embodiment

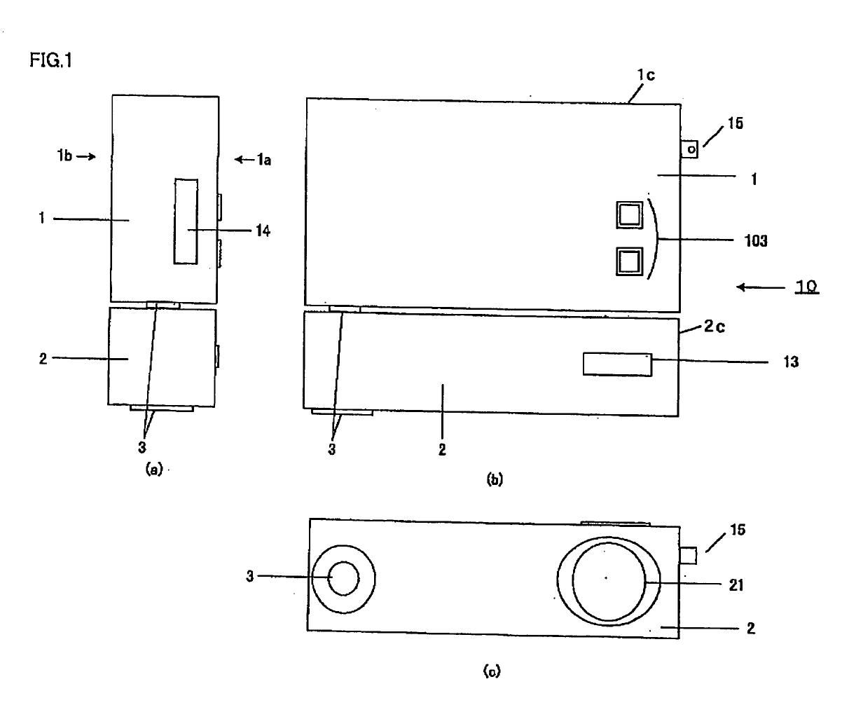

FIGS. 1(a) through (c) are three side views of a compact projector according to the first embodiment of the present invention. FIG. 1(a) is a left side view, FIG. 1(b) is a plan view, and FIG. 1(c) is a front view. In this projector 10, two chassis that respectively are included in a control unit 1 and a projection unit 2 are freely rotatably hinged together by a hinge unit 3. The structural elements of the control unit 1 are housed within a chassis 1c, while the structural elements of the projection unit 2 are housed within a chassis 2c. The hinge unit 3 is provided near an end portion of the projection unit 2 in the longitudinal direction, and the rotation shaft of this hinge unit 3 is orthogonal to the two surfaces of the control unit 1 and the projection unit 2 that mutually oppose one another. A click mechanism not shown in the figures is provided to the hinge unit 3, and this click mechanism operates at positions where the relative angle θ between the control unit 1 and the projection unit 2 is at, for example, 90°, 180°, and 270°. It should be understood that this hinge unit 3 may be constructed so as to be able to support these units at any desired angles, not necessarily the click positions described above. And the control unit 1 is provided with a strap fixing member 15, to which a strap or the like not shown in the figures can be attached.

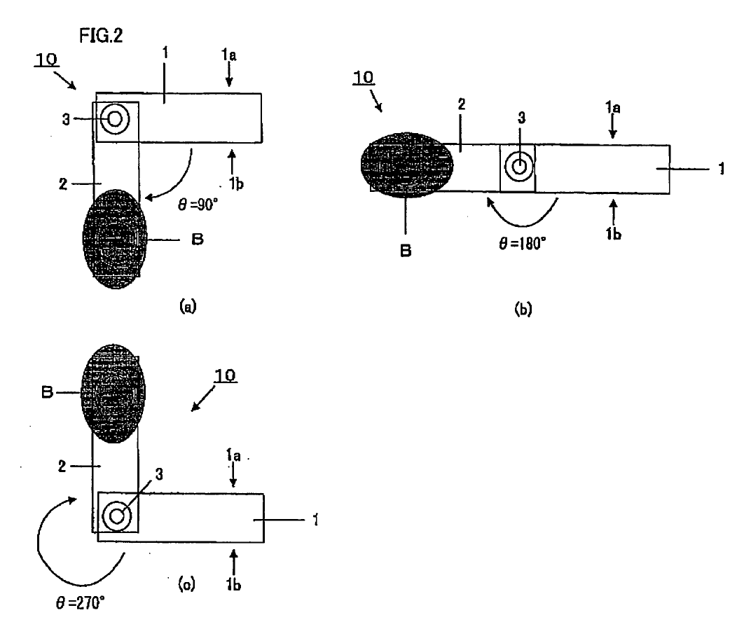

FIGS. 2(a) through 2(c) are figures showing examples of three modes of the projector 10 to which the hinge unit 3 may be rotated. FIG. 2(a) is a figure in which the projection unit 2 has been rotated to a relative angle θ=90° around the hinge unit 3 as a rotation shaft, FIG. 2(b) is a figure in which the projection unit 2 has been rotated to a relative angle θ=180° around the hinge unit 3 as a rotation shaft, and FIG. 2(c) is a figure in which the projection unit 2 has been rotated to a relative angle θ=270° around the hinge unit 3 as a rotation shaft. In each of FIGS. 2(a) through 2(c), the ray bundle B indicates a projection beam that is emitted from the projection unit 2. The states of FIGS. 2(a) and 2(b) are principally used when this device is held in the hand. Moreover, the state of FIG. 2(c) is used when the device is held in the hand, and also when it is placed upon a flat support.

In the case of the mode of FIG. 2(c), even though the projection is mounted upon a flat surface, it is still possible to actuate actuation members 103, since the projector is laid with its surface 1b downwards. Since the control unit 1 is larger in size than the projection unit 2, accordingly the attitude of the projector 10 is stable, even though the projection unit 2, that is rotated, does not contact the surface upon which the projector rests.

In FIGS. 1(a) through 1(c), it is desirable for the position of an opening 21 of the projection unit 2 to lie upon the opposite side to the hinge unit 3, from the center of the projection unit 2 in its longitudinal direction.

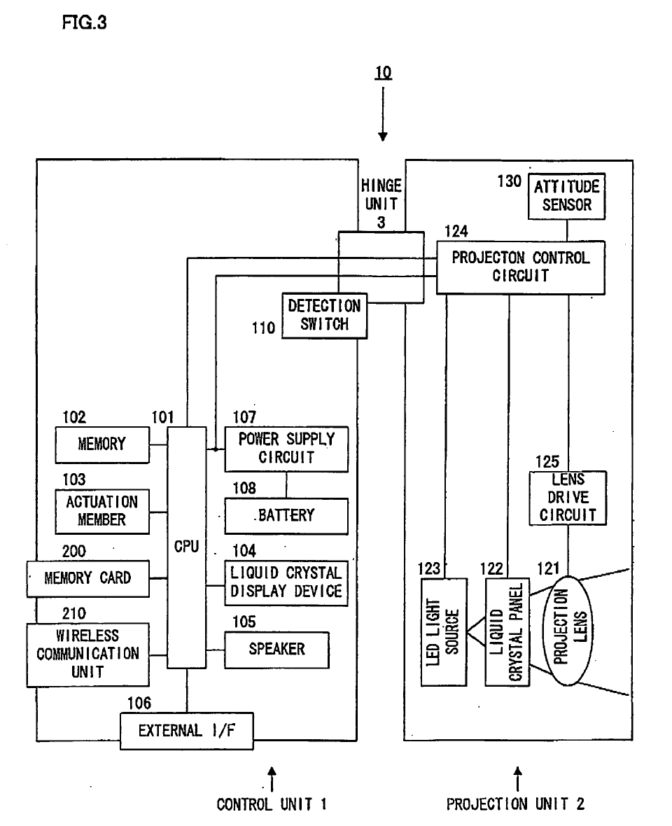

FIG. 3 is a block diagram for explanation of the circuit structure of this projector 10. In FIG. 3, to the control unit 1, there are provided a CPU 101, a memory 102, the actuation members 103, a liquid crystal display device 104, a speaker 105, an external interface (I/F) 106, and a power supply circuit 107; and a battery 108, a memory card 200, and a wireless communication unit 210 are also attached.

To the projection unit 2 there are provided a projection lens 121, a liquid crystal panel 122, a LED light source 123, a projection control circuit 124, a lens drive circuit 125, and an attitude sensor 130.

The CPU 101 is a controller, and, based upon a control program, it performs predetermined calculations and the like using signals that are inputted from the various sections that make up the projector 10, and controls the projection operation of the projector 10 by sending out control signals to the various sections of the projector 10. It should be understood that this control program is stored in a non-volatile memory within the CPU 101, not shown in the figures. By image processing, the CPU 101 also performs trapezoidal distortion correction, i.e. so called keystone compensation, upon the data for an image to be projected by the projector 10.

The memory 102 is used as a working memory for the CPU 101. The actuation members 103 include a main switch and a light source ON/OFF switch and the like, and output actuation signals to the CPU 101 according to actuation of these various switches.

The memory card 200 is made from non-volatile memory, and is built so as to be fittable to, and removable from, a card slot 14 of the control unit 1 (refer to FIG. 1(a)). According to commands from the CPU 101, it is possible to write data such as image data or audio data or the like upon this memory card 200, to store this data therein, and to read data out therefrom.

The wireless communication unit 210 is built so as to be fittable to, and removable from, the control unit 1, and it transmits and receives data to and from an external device according to a command from the CPU 101. The data that is thus transmitted and received may be image data or audio data, or control data for the projector 10.

According to a command from the CPU 101, the external interface 106 transmits and receives data to and from an external device via a cable or a cradle not shown in the figures. The data that is thus transmitted and received may be image data or audio data, or control data for the projector 10.

The speaker 105 replays audio from an audio signal outputted from the CPU 101. And the liquid crystal display device 104 displays information such as text or the like, upon a command from the CPU 101. Such text information may be information indicating the operational state of the projector 10, or an actuation menu or the like.

The battery 108 consists of a secondary battery that can be charged, and supplies electrical power to the various sections within the projector 10. The power supply circuit 107 includes a DC/DC conversion circuit, a charging circuit, and a voltage detection circuit, and converts the voltage of the battery 108 into the voltages required by the various sections within the projector 10. Moreover, if the voltage of the battery 108 is low and its remaining capacity is reduced, this power supply circuit 107 charges up the battery 108 with a charging electrical current that is supplied via the external interface (I/F) 106.

An opening and closing angle detection switch 110 detects the rotational angle of the hinge unit 3, and, if it detects that the relative angle θ between the control unit 1 and the projection unit 2 is at 0° then it outputs an OFF signal to the CPU 101, while with other angles it outputs an ON signal. If the relative angle θ between the control unit 1 and the projection unit 2 is 0°, then this is presumed to be the storage attitude.

The projection control circuit 124 controls each of the liquid crystal panel 122, the LED light source 123, and the lens drive circuit 125 according to commands from the CPU 101. The projection control circuit 124 supplies electrical current to the LED light source 123 according to a LED drive signal that is outputted from the CPU 101. And the LED light source 123 illuminates the liquid crystal panel 122 at a brightness corresponding to the electrical current that is thus supplied.

The projection control circuit 124 generates a liquid crystal panel drive signal corresponding to image data that is transmitted from the CPU 101, and drives the liquid crystal panel 122 with this generated drive signal. In concrete terms, it applies a voltage to each picture element in the liquid crystal layer corresponding to the image signal. The orientation of the liquid crystal molecules in the liquid crystal layer to which voltage is applied changes, and the transmittivity to light of that liquid crystal layer changes. In this manner, the liquid crystal panel 122 forms an optical image by modulating the light from the light source 123 in correspondence with the image signal. The liquid crystal panel 122 has an effective picture element region which is approximately square, and is built so that the number of effective picture elements in the vertical direction and in the horizontal direction is the same.

The lens drive circuit 125 shifts the projection lens 121 forwards and backwards along a direction that is orthogonal to an optical axis, based upon a control signal outputted from the projection control circuit 124. The projection lens 121 projects the optical image emitted from the liquid crystal panel 122 towards a screen or the like.

The attitude sensor 130 detects the attitude of the projection unit 2, and outputs its detection signal to the CPU 101 via the projection control circuit 124. Based upon this, the CPU 101 decides whether the projector 10 is in the state of being in the storage attitude, or is in any of the states of FIG. 2(a) through 2(c).

### (Offsetting of the Projected Image)

The CPU 101 changes the direction of emission of the ray bundle B by shifting the projection lens 121 in a direction orthogonal to the optical axis, and thereby offsets the projected image. And, if the CPU 101 decides that the state of FIG. 2(a) holds, then it causes the ray bundle B to be emitted so that no portion of the ray bundle B interferes with the surface upon which the projector is mounted, i.e. in a direction that is separated from the prolongation of the surface 1a. In other words, the CPU 101 causes the projection lens 121 to be shifted so that the upper edge of the ray bundle B is directed lower than the prolongation of the surface 1a. And, according to this, if the projector 10 is mounted with its surface 1a downwards, then the lower edge of the ray bundle B comes to be directed above the prolongation of the surface 1a, in other words above the surface on which the projector is mounted.

Moreover, if the CPU 101 decides that the state of FIG. 2(c) holds, then it causes the ray bundle B to be emitted so that no portion of the ray bundle B interferes with the surface upon which the projector is mounted, i.e. in a direction that is separated from the prolongation of the surface 1b. In other words, the CPU 101 causes the projection lens 121 to be shifted so that the lower edge of the ray bundle B is directed higher than the prolongation of the surface 1b.

Furthermore, if the CPU 101 decides that the state of FIG. 2(b) holds, then it causes the projection lens 121 to be shifted so that the lower edge of the ray bundle B is directed higher than the prolongation of the surface 1b. Moreover, if the CPU 101 decides that the state of the storage attitude shown in FIGS. 1(a) through 1(c) holds, then it causes the projection lens 121 to be shifted so that the lower edge of the ray bundle B is directed higher than the prolongation of the surface 1b.

It would also be acceptable to arrange to provide the offsetting of the projected image, not by shifting the projection lens 121, but rather by shifting the liquid crystal panel 122 or the LED light source 123 in a direction orthogonal to the optical axis. In other words, it is possible to implement offsetting of the projected image by changing the relative positional relationship between the projection lens 121 and the liquid crystal panel 122 in a direction orthogonal to the optical axis.

### (Keystone Compensation of the Image to be Projected)

When at least one portion of the projection lens 121, the liquid crystal panel 122, and the LED light source 123 is shifted in a direction that is orthogonal to the optical axis, then keystone compensation is performed upon the data being projected according to this shifting amount. Simply by imparting the above described offsetting upon the projected image, it is changed into a trapezoidal shape. Thus, the CPU 101 performs electrical keystone compensation by image processing, in order to compensate the projected image back from its trapezoidal shape to a rectangular shape. Initial compensation values are stored within the CPU 101 in advance, for compensating the projected image to a square shape in the various states shown in FIGS. 2(a) through 2(c). And, based upon these initial compensation values, the CPU 101 performs keystone compensation processing within the memory 102 upon the data for the image to be projected.

### (The Main Processing)

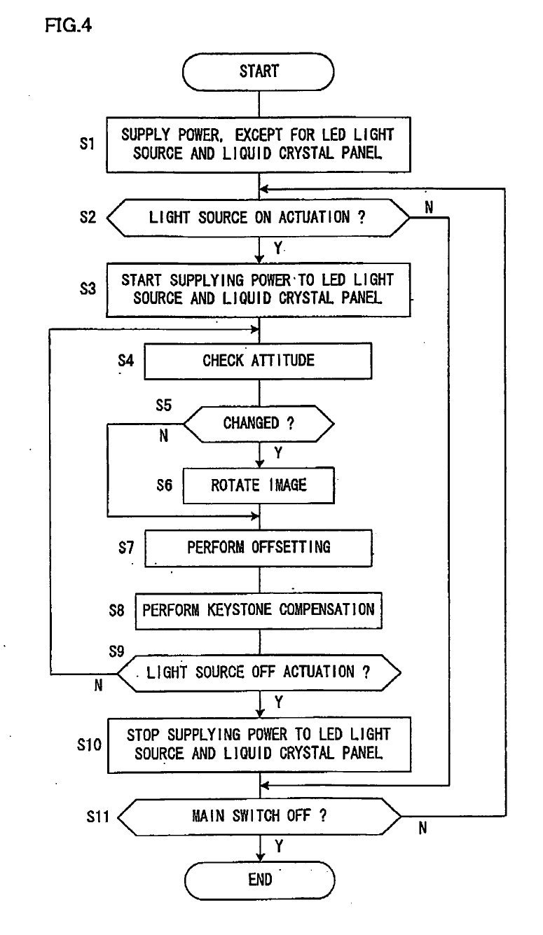

The main processing flow performed by the CPU 101 of the projector 10 described above will now be explained with reference to the flow chart of FIG. 4. The processing of FIG. 4 is started when a main switch that is included in the actuation members 103 is actuated to ON. In a step S1 of FIG. 4, the CPU 101 issues a command to the power supply circuit 107 and causes it to start supply of electricity to the various sections, excluding the LED light source 123 and the liquid crystal panel 122, and then the flow of control proceeds to a step S2.

In this step S2, the CPU 101 decides whether or not actuation has been performed to turn the light source ON (i.e. to start projection). If either an ON actuation signal from a light source ON/OFF switch that is included in the actuation members 103 and an ON signal from the opening and closing angle detection switch 110 is newly inputted, then the CPU 101 reaches an affirmative decision in this step S2 and proceeds to a step S3, while if no such new signal is being inputted then the CPU 101 reaches a negative decision in this step S2 and control is transferred to a step S11.

In this step S3, the CPU 101 issues a command to the projection control circuit 124 to start supply of electrical power to the LED light source 123 and the liquid crystal panel 122, and then the flow of control proceeds to a step S4. Due to this, the ray bundle B is emitted from the projector 10, and an optical image is projected upon the screen.

The projector 10 is adapted to project and to replay contents selected from the following projection sources. The CPU 101 selects the contents to be projected according to a setting actuation signal from an actuation member 103. And the CPU 101 transmits data for the contents that have thus been selected to the projection control circuit 124, and creates an optical image upon the liquid crystal panel 122 according to that data.

Source #1: Image and audio from data read out from the memory card 200;

Source #2: Image and audio from data received by the wireless communication unit 210;

Source #3: Image and audio from data inputted from the external interface 106;

Source #4: Image and audio for setting functions of the projector 10.

In the step S4, the CPU 101 performs an attitude check of the projector 10. Based upon an attitude detection signal from the attitude sensor 130, the CPU 101 determines which attitude the projector 10 takes among the states of FIG. 1(a) through 1(c) and FIG. 2(a) through 2(c), and then the flow of control proceeds to a step S5.

In the step S5, the CPU 101 decides whether or not the attitude of the projector 10 is changed. And if the attitude that was decided upon in the step S4 is different from the attitude that was decided the time before, then the CPU 101 reaches an affirmative decision in this step S5 and the flow of control proceeds to a step S6, while if the attitude is the same as the attitude that was decided the time before, then the CPU 101 reaches a negative decision in the step S5 and the flow of control is transferred to a step S7.

In the step S6, the CPU 101 rotates the projected image. If in the step S4 the CPU 101 has decided that the projector is in the storage attitude state shown in FIGS. 1(a) through 1(c), then it commands the projection control circuit 124 to generate an optical image upon the liquid crystal panel 122 in the normal orientation, according to the data for the contents to be projected.

### (The Case of a Landscape Format Image

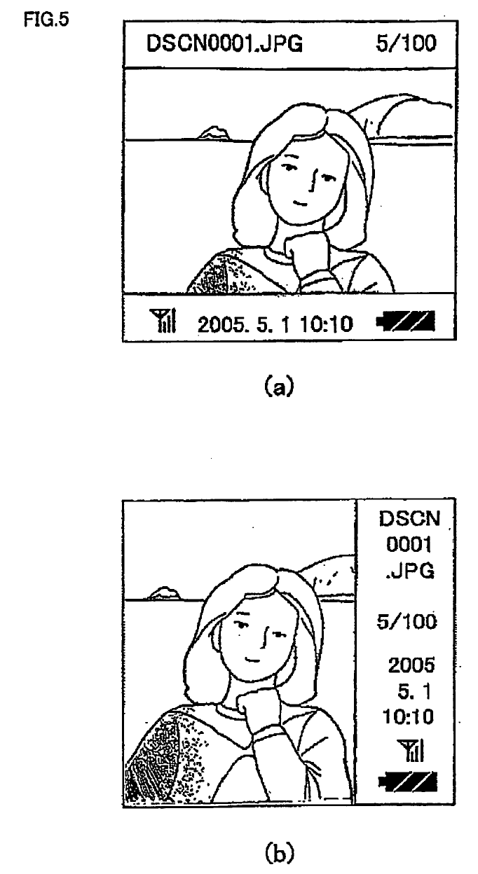

FIG. 5(a) is a figure showing an example of the projected image in the case when the image to be projected is a landscape format image. When all of the effective picture element regions of the liquid crystal panel 122 are used, then the projected image is of approximately square shape. Here, the image to be projected agrees with the contents for projection selected from any one of the above described Source #1 through Source #4, and the projected image means the entire optical image that is projected by the projector 10, including the image to be projected.

In the example of FIG. 5(a), along with the long side of the landscape format image (i.e. its horizontal direction) corresponding to one side (the horizontal direction) of the projected image, blank margins are provided vertically above and below the short side direction of the landscape projected image (i.e. its vertical direction), and information about the projected contents and information showing the operational state of the projector 10 is appended in this blank margin, so as to define an approximately square shape. “DSCN0001.JPG” in FIG. 5(a) is the file name of the contents, “5/100” is the number of this contents file, “2005.5.1 10:10” is the date and time of creation of the file, the mark that depicts an antenna shows the state of communication of the wireless communication unit 210, and the mark that depicts a battery shows the remaining capacity of the battery 108. It should be understood that it would also be acceptable to provide this blank margin only at the upper portion of the landscape format image, or to provide it only at the lower portion of the landscape format image.

If in the step S4 the state of FIG. 2(a) has been decided upon, then the CPU 101 issues a command to the projection control circuit 124, and causes the image formed upon the liquid crystal panel 122 to be rotated, so that the optical image that is projected is rotated rightwards through 90° from its normal orientation. Thus, the projected image after rotation is the same as shown in FIG. 5(a).

Furthermore, if in the step S4 the state of FIG. 2(c) has been decided upon, then the CPU 101 issues a command to the projection control circuit 124, and causes the image formed upon the liquid crystal panel 122 to be rotated, so that the optical image that is projected is rotated leftwards through 90° from its normal orientation. Thus, the projected image after rotation is the same as shown in FIG. 5(a).

Yet further, if in the step S4 the state of FIG. 2(b) has been decided upon, then the CPU 101 issues a command to the projection control circuit 124, and causes the image formed upon the liquid crystal panel 122 to be rotated, so that the optical image that is projected is rotated through 180° from its normal orientation. Thus, the projected image after rotation is the same as shown in FIG. 5(a).

### (The Case of a Portrait Format Image)

FIG. 5(b) is a figure showing an example of the projected image in the case when the image to be projected is a portrait format image. In the example of FIG. 5(b), along with the long side of the portrait format image (i.e. its vertical direction) corresponding to one side (the vertical direction) of the projected image, a blank margin is provided on the right side of the short side direction of the portrait projected image (i.e. its horizontal direction), and information about the projected contents and information showing the operational state of the projector 10 is appended in this blank margin, so as to define an approximately square shape. Since the information that is appended in this blank margin of FIG. 5(b) is the same as in the case of FIG. 5(a), the explanation thereof will be omitted. It should be understood that it would also be acceptable to provide this blank margin only upon the left side of the portrait format image, or to provide it upon both the left and right sides of the landscape format image.

If in the step S4 the state of FIG. 2(a) has been decided upon, then the CPU 101 issues a command to the projection control circuit 124, and causes the image formed upon the liquid crystal panel 122 to be rotated, so that the optical image that is projected is rotated rightwards through 90° from its normal orientation. Thus, the projected image after rotation is the same as shown in FIG. 5(b).

Furthermore, if in the step S4 the state of FIG. 2(c) has been decided upon, then the CPU 101 issues a command to the projection control circuit 124, and causes the image formed upon the liquid crystal panel 122 to be rotated, so that the optical image that is projected is rotated leftwards through 90° from its normal orientation. Thus, the projected image after rotation is the same as shown in FIG. 5(b).

Moreover, if in the step S4 the state of FIG. 2(b) has been decided upon, then the CPU 101 issues a command to the projection control circuit 124, and causes the image formed upon the liquid crystal panel 122 to be rotated, so that the optical image that is projected is rotated through 180° from its normal orientation. Thus, the projected image after rotation is the same as shown in FIG. 5(b).

In the step S7 of FIG. 4, the CPU 101 performs offsetting processing of the projected image, and then the flow of control proceeds to a step S8. The CPU 101 issues a command to the projection control circuit 124 to shift the projection lens 121, so as to ensure that no portion of the ray bundle B is interfered with. Data that specifies the shifting amount for the projection lens 121 is stored in advance within the CPU 101. The CPU 101 reads out the data for the shifting amount that corresponds to the state of the projector 10 as checked in the step S4, and sends the shift command to the projection control circuit 124 along with this data.

In the step S8, the CPU 101 performs Keystone processing upon the projected image, and then the flow of control proceeds to a step S9. The CPU 101 reads out an initial compensation value that corresponds to the state of the projector 10 as checked in the step S4, and transmits data for the projected image to the projection control circuit 124, after having performed compensation upon it using this compensation value.

In the step S9, the CPU 101 decides whether or not actuation has been performed to turn the light source OFF (i.e. to terminate projection). If either an OFF actuation signal from the light source ON/OFF switch that constitutes one of the actuation members 103, or an OFF signal from the opening and closing angle detection switch 110 is newly being inputted, then the CPU 101 reaches an affirmative decision in the step S9, and the flow of control proceeds to the step S10. But, if no such new signal is being inputted, then a negative decision is reached in the step S9, and the flow of control returns to the step S4. In this case of returning to the step S4, projection is continued while checking the attitude of the projector.

In the step S10, the CPU 101 issues a command to the projection control circuit 124 and stops supply of electrical power to the LED light source 123 and the liquid crystal panel 122, and then the flow of control proceeds to a step S11. Due to this, the optical image ceases to be projected from the projector 10. It should be understood that, since the supply of electrical power is continued, not only to the CPU 101, but also to the various circuits such as the memory 102, the memory card 200, the wireless communication unit 210, the external interface 106, and the like, accordingly, if the contents for projection is from the Source #1 described above, then the information of the memory card 200 and the data that has been read in from the memory card 200 is stored in the memory 102. In a similar manner, if the contents for projection is from the Source #2 described above, then communication between the wireless communication unit 210 and the external device is continued, and the data that is received by the wireless communication unit 210 is stored in the memory 102. Moreover, if the contents for projection is from the Source #3 described above, then communication between the external interface 106 and the external device is continued, and the data that is received by the external interface 106 is stored in the memory 102.

In the step S11, a decision is made as to whether or not the main switch, that constitutes one of the actuation members 103, has been actuated to OFF. If an OFF actuation signal is being inputted, then the CPU 101 reaches an affirmative decision in this step S11 and performs power supply OFF processing so as to terminate the supply of electrical power to the various sections of the projector, and then the processing of FIG. 4 terminates. On the other hand, if no such OFF actuation signal is being inputted, then the CPU 101 reaches a negative decision in this step S11, and the flow of control returns to the step S2.

After the flow of control has returned to the step S2, if actuation to turn the light source ON is being performed, then projection is immediately resumed using the data that is being stored in the memory 102.

According to the first embodiment as explained above, the following operational effects are obtained.

(1) In this projector 10, the projection unit 2 that includes the projection optical system (including the projection lens 121 and the opening 21) and the control unit 1 that includes the actuation members 103 are separated from one another. And the projection unit 2 and the control unit 1 are supported by the hinge unit 3 so as to rotate freely, with the structure being such that an optical image is projected from the projection unit 2 in a plane that is orthogonal to the rotation axis of the hinge unit 3. Due to this, it is possible to change the projection attitude in a simple manner, only by rotating the hinge unit 3, with the control unit 1 still in the same state as being mounted upon a surface (or as grasped), and moreover while still projecting in the direction of the rotation shaft of the hinge unit 3.

(2) With this projector 10, it is arranged to rotate the image to be projected automatically, according to the attitude of the projection unit 2 that is checked using the attitude sensor 130. In concrete terms, the rotational angle of the image to be projected is determined in accordance with the relative angle θ between the control unit 1 and the projection unit 2. By doing this, it is possible to make the projected image always be an erect image, irrespective of changes in the projection attitude.

(3) Since the effective picture element region of the liquid crystal panel 122 is made in an approximately square shape, if the aspect ratio of the contents to be projected is not 1:1, in other words if the image to be projected is of a rectangular shape, then it is possible always to project an image of the same size, irrespective of whether it is a landscape format image or a portrait format image.

(4) If the contents to be projected is a landscape format image, then, along with making the long side of this landscape format image (i.e. its horizontal direction) correspond to one side (the horizontal direction) of the projected image, it is also arranged to provide blank margins above and below the landscape format image, and to append information about the projected contents or information that indicates the operational state of the projector 10 in these blank margins. By doing this, the appended information constitutes no hindrance to appreciation of the image, as compared with the case of appending information by overlaying it over the contents image.

(5) If the contents to be projected is a portrait format image, then, along with making the long side of this portrait format image (i.e. its vertical direction) correspond to one side (the vertical direction) of the projected image, it is also arranged to provide a blank margin at the right side of the portrait format image, and to append information about the projected contents or information that indicates the operational state of the projector 10 in this blank margin; and accordingly, in a manner similar to (4) described above, this appended information constitutes no hindrance to appreciation of the image.

(6) Since it is arranged to position the hinge unit 3 at one end of the projection unit 2 in its longitudinal direction, and to position the opening 21 at its other end, accordingly, particularly in the states of FIGS. 2(a) and 2(c), it is possible to secure more height from the flat surface upon which the control unit 1 is mounted to the ray bundle B. By making the ray bundle B, in other words the position of the opening 21, higher, the possibility of a portion of the ray bundle B being interfered with by the mounting surface becomes small. If the projector 10 is made ultra compact (for example as small as a cigarette case or smaller), then it is very important to secure height from the flat mounting surface to the ray bundle B.

(7) The opening and closing angle detection switch 110 detects the rotational angle of the hinge unit 3, and outputs an ON signal when the projector 10 is not in its storage attitude. And it is arranged to start projection (in the step S3) when an ON signal is inputted to the CPU 101 from the opening and closing angle detection switch 110, even though the light source ON/OFF switch is not actuated to ON. Accordingly, the convenience of use from the point of view of the user becomes better, as compared to the case when, in order to start projection, having changed the rotational angle of the hinge unit 3 to a non-storage attitude, the light source ON/OFF switch must further be actuated to ON.

(8) The opening and closing angle detection switch 110 detects the rotational angle of the hinge unit 3, and outputs an OFF signal when the projector 10 is in its storage attitude. And it is arranged for the CPU 101 to stop projection (in the step S10) when, during projection, an OFF signal is newly inputted from the opening and closing angle detection switch 110, or the light source ON/OFF switch is newly actuated to OFF. Accordingly, the convenience of use from the point of view of the user in order to terminate projection becomes better, as compared with the case in which, after actuating the light source ON/OFF switch to OFF, the rotational angle of the hinge unit 3 must further be changed to the storage attitude.

(9) Since, in (8) described above, until the main switch is actuated to OFF, it is arranged to store the data in the memory 102 with only the supply of electrical power to the LED light source 123 and the liquid crystal panel 122 stopped, accordingly, if light source ON actuation is performed for a second time, it is possible quickly to resume projection using the data that is stored in the memory 102.

Although, in the above explanation, it is arranged to rotate the image to be projected automatically according to the attitude that is checked by using the attitude sensor 130, it would also be acceptable to provide a structure in which it is possible to change over between performing such automatic rotation, and not doing so. If the CPU 101 is to permit automatic rotation, then the processing of the steps S5 and S6 of FIG. 4 is performed, while, if automatic rotation is not to be permitted, then the processing of the steps S5 and S6 is skipped. By skipping the steps S5 and S6, the automatic rotation of the projected image ceases to be performed. The command to the projector 10 specifying whether to permit, or not to permit, automatic rotation, is given with a permitted/not permitted changeover actuation signal from an actuation member 103.

Furthermore, it would also be acceptable to arrange to rotate the image to be projected irrespective of the attitude checked by using the attitude sensor 130. For example, the CPU 101 might rotate the image that is formed upon the liquid crystal panel 122 so as to rotate the optical image that is projected from its normal orientation rightwards by 90°, each time an image rotation actuation signal is inputted from an actuation member 103. If the data for the contents to be projected is inverted top and bottom, or is rotated by 90° to the left or to the right from its proper position, then it is possible to ensure that the projected image is an erect image in the correct orientation, irrespective of the attitude of the projector 10.

Although an example has been explained in which this projector 10 is mounted upon a mounting plane with the upper surface 1a or the lower surface 1b of the control unit facing downwards, it would also be acceptable to provide magnets in the surface 1a and the surface 1b, so as to provide a structure with which the projector may be used by being adhered to a metallic surface such as a ceiling or a wall or the like.

### Second Embodiment

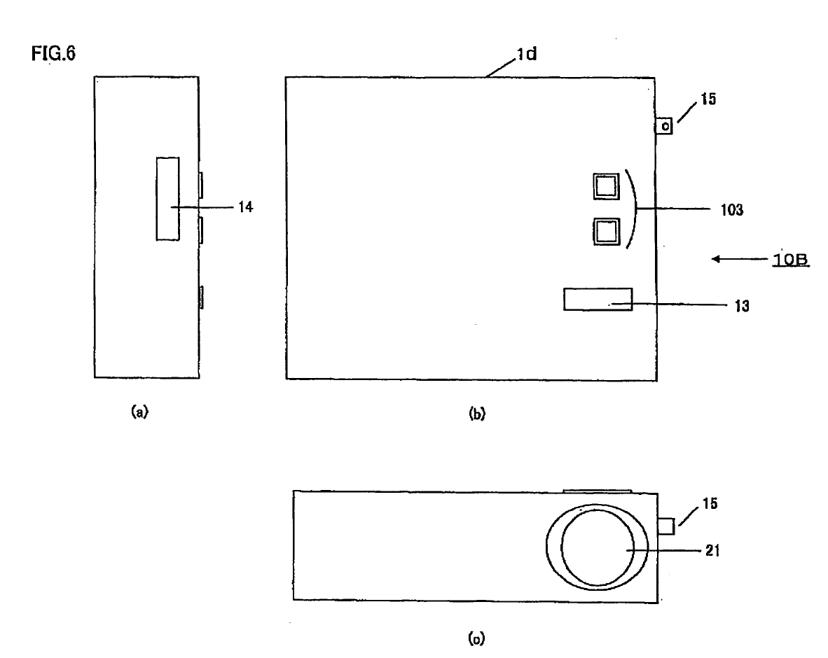

FIGS. 6(a) through 6(c) are views from three sides of a compact projector according to the second embodiment of the present invention. FIG. 6(a) is a left side view, FIG. 6(b) is a plan view, and FIG. 6(c) is a front view. This projector 10B differs from that of the first embodiment in that all of its structural elements are contained within a single chassis 1d. The position of the opening 21 is arranged adjacent to one end of the projector 10B (in this example, the right side in FIG. 2(c)) in the front longitudinal direction. The strap fixing member 15, to which a strap or the like not shown in the figures can be fitted, is provided to this projector 10B.

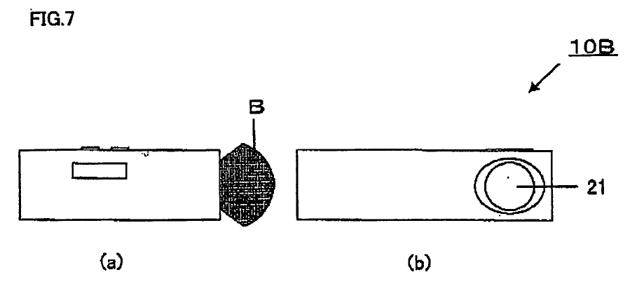

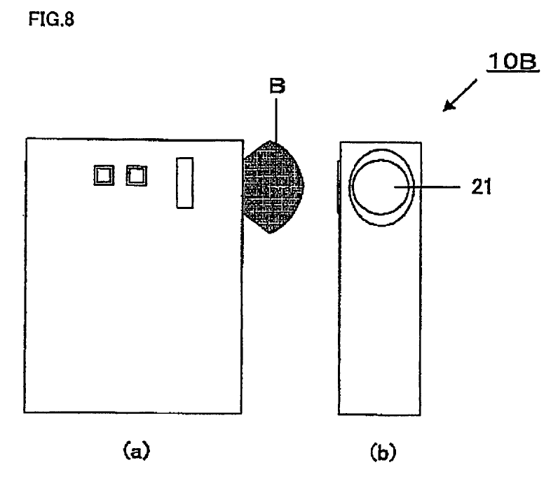

This projector 10B may be used in the state of being mounted horizontally, mounted vertically, or grasped. FIG. 7(a) is a left side view when this projector is mounted horizontally, and FIG. 7(b) is a front view when it is mounted horizontally. And FIG. 8(a) is a left side view when this projector is mounted vertically, and FIG. 8(b) is a front view when it is mounted vertically. In vertical mounting, the projector is mounted so that the opening 21 is separated from the support plane (on the upper side in FIGS. 8(a) and 8(b)). In each of FIG. 7(a) and FIG. 8(a), the ray bundle B indicates the projected beam that is emitted from the opening 21.

Similar circuits and structural members are contained in the chassis of this projector 10B as in the case of the projector 10 of the first embodiment, apart from the hinge unit 3 and the opening and closing angle detection switch 110. The battery 108, that is one of the structural members with the greatest mass, is disposed within the projector 10B at its mounting plane side in the front longitudinal direction (in FIGS. 8(a) and 8(b), at its lower side). Due to this, the center of gravity of the projector 10B when it is vertically mounted with the opening 21 upwards is lowered towards the side of the mounting plane, so that the projector 10B is stable. The attitude sensor 130 detects the overall attitude of the projector 10B. In concrete terms, it detects whether the projector 10B is mounted horizontally upon a horizontal surface as shown in FIGS. 7(a) and 7(b), or is mounted vertically as shown in FIGS. 8(a) and 8(b).

The CPU 101 of this projector 10B performs similar main processing to that of the projector 10 of the first embodiment (refer to FIG. 4). However, since the opening and closing angle detection switch 110 that detects the opening and closing angle of the hinge unit 3 is omitted, accordingly it is sufficient to make decisions in the steps S2 and S9 based only on the actuation signal from the light source ON/OFF switch.

According to the second embodiment as explained above, the following operational effects are obtained.

(1) Since the opening 21 is disposed in the vicinity of one end of the projector 10B in its front longitudinal direction, and, within the projector 10B, the battery 108 is disposed on the opposite side to the opening 21 (the lower side in FIGS. 8(a) and 8(b)), accordingly the center of gravity of the projector 10B when it is mounted vertically with the opening 21 upwards is lowered towards its lower side, and thus the projector 10B is stable.

(2) Since, in the vertically mounted position described above in (1), it is possible to secure more height from the mounting surface to the opening 21, accordingly the possibility that a portion of the ray bundle B may be eclipsed by the mounting surface becomes small.

### Variant Embodiment

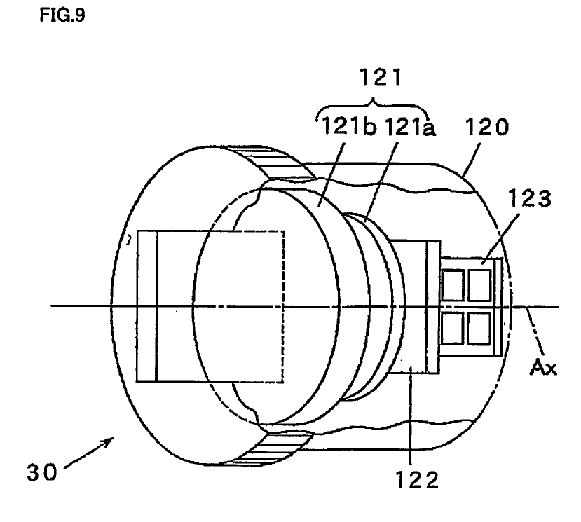

It would also be acceptable to provide a structure in which the rotation of the projected image is performed, not by the method of electrically rotating the image that is formed upon the liquid crystal panel 122, but by a method of physically rotating a projection module that includes the projection lens 121, the liquid crystal panel 122, and the LED light source 123. FIG. 9 is a figure for explanation of a projection module 30 that employs this method.

In FIG. 9, all of the LED light source 123, the liquid crystal panel 122, and two lenses 121a and 121b that make up the projection lens 121 are contained within a cylinder member 120. It should be understood that an actuator that drives these two lenses 121a and 121b forwards and backwards, and the projection control circuit 124, are omitted from this figure. When the projection module 30 is rotated, the liquid crystal panel 122 is rotated about the optical axis Ax of illumination by the LED light source 123 as a center. Since the liquid crystal panel 122 and the projection lens 121 are rotated in this manner by the rotation of the projection module 30, accordingly it is possible to rotate the projected image.

The projection module 30 is rotationally driven by a motor not shown in the figures, and this motor is rotated according to commands from the CPU 101. It is possible to rotate the image to be projected automatically by the CPU 101 issuing a rotation command to the motor, corresponding to the attitude of the projector 10 that the CPU 101 has checked by using the attitude sensor 130. Moreover, if the CPU 101 issues a rotation command to the motor corresponding to a rotation actuation signal from an actuation member 103, then it is possible to rotate the projected image irrespective of the attitude of the projector 10 (10B).

### (The Remaining Battery Capacity)

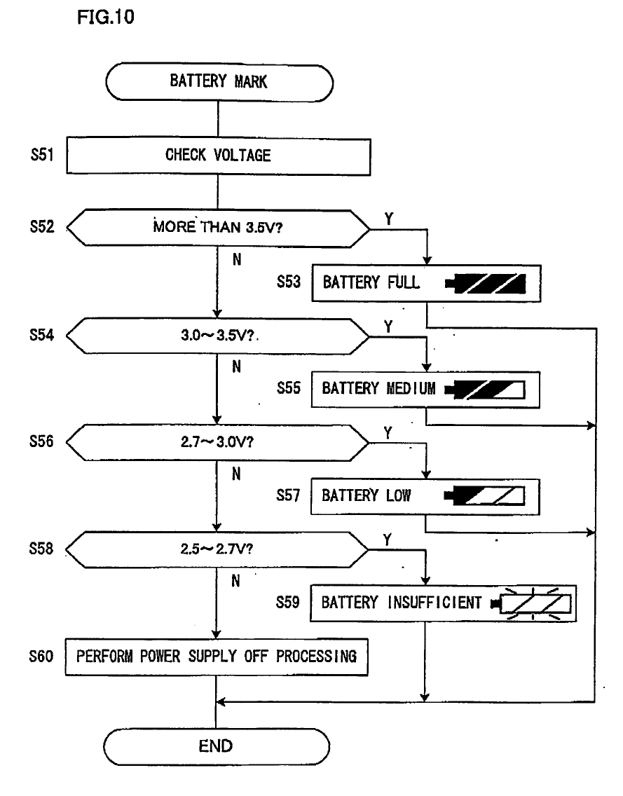

Processing for determining a battery mark that is to be appended in the blank margin of the projected image described above will now be explained with reference to the flow chart of FIG. 10. It should be understood that this battery mark indicates the remaining capacity of the battery 108. The CPU 101 starts the processing shown in FIG. 10 periodically at a predetermined interval while the main switch of the projector 10 (10B) is turned ON. In a step S51 of FIG. 10, the CPU 101 checks the voltage of the battery, and then the flow of control proceeds to a step S52. This voltage checking is performed by inputting a detection signal that is detected by the power supply circuit 107.

In the step S52, the CPU 101 decides whether or not the voltage of the battery 108 is greater than or equal to, for example, 3.5 V. If a voltage that is greater than or equal to 3.5 V is detected, then the CPU 101 makes an affirmative decision in the step S52 and the flow of control proceeds to a step S53, while if the detected voltage is lower than 3.5 V then a negative decision is made in the step S52, and the flow of control is transferred to a step S54.

In the step S53, the CPU 101 considers that the battery is fully charged, and determines upon a battery mark that indicates that the battery is full (all of the three segments that constitute the battery mark are illuminated), and then the processing of FIG. 10 terminates. The battery mark that has been decided upon is appended in the blank margin region shown by way of example in FIGS. 5(a) and 5(b).

In the step S54, the CPU 101 decides whether or not the voltage of the battery 108 is greater than or equal to 3.0 V and is less than 3.5 V. If a voltage of 3.0 V˜3.5 V is detected, then the CPU 101 makes an affirmative decision in the step S54 and the flow of control proceeds to a step S55, while if the detected voltage is lower than 3.0 V then a negative decision is made in the step S54, and the flow of control is transferred to a step S56.

In the step S55, the CPU 101 considers that the charge ratio of the battery is intermediate, and determines upon a battery mark that indicates that the battery is part charged (two of the segments are illuminated, and one is not illuminated), and then the processing of FIG. 10 terminates. The battery mark that has been decided upon is appended in the blank margin region shown by way of example in FIGS. 5(a) and 5(b).

In the step S56, the CPU 101 decides whether or not the voltage of the battery 108 is greater than or equal to 2.7 V and is less than 3.0 V. If a voltage of 2.7 V˜3.0 V is detected, then the CPU 101 makes an affirmative decision in the step S56 and the flow of control proceeds to a step S57, while if the detected voltage is lower than 2.7 V then a negative decision is made in the step S56, and the flow of control is transferred to a step S58.

In the step S57, the CPU 101 considers that the charge ratio of the battery is low, and determines upon a battery mark that indicates that the battery is low (one of the segments is illuminated, and two are not illuminated), and then the processing of FIG. 10 terminates. The battery mark that has been decided upon is appended in the blank margin region shown by way of example in FIGS. 5(a) and 5(b).

In the step S58, the CPU 101 decides whether or not the voltage of the battery 108 is greater than or equal to 2.5 V and is less than 2.7 V. If a voltage of 2.5 V˜2.7 V is detected, then the CPU 101 makes an affirmative decision in the step S58 and the flow of control proceeds to a step S59, while if the detected voltage is lower than 2.5 V then a negative decision is made in the step S58, and the flow of control is transferred to a step S60.

In the step S59, the CPU 101 considers that the charge ratio of the battery is extremely low, and determines upon a battery mark that indicates that the battery is insufficient (all three of the segments are not illuminated, and the frame is blinked), and then the processing of FIG. 10 terminates. The battery mark that has been decided upon is appended in the blank margin region shown by way of example in FIGS. 5(a) and 5(b).

In the step S60, since the necessary voltage for operating the various sections within the projector 10 (10B) cannot be obtained, accordingly the CPU 101 performs power supply OFF processing so as to stop supplying electrical power to these various sections, and then the processing of FIG. 10 is terminated. It should be understood that the ranges for that the battery marks are determined are not limited by the example described above.

Although, in the above explanation, a case is explained in which the structure includes an optical image formation element that employs the liquid crystal panel 122, and an optical image was obtained by illuminating an image upon the liquid crystal panel 122 with light from the LED light source 123, it would also be acceptable to provide a structure in which a self-luminescent type optical image formation element is used. In this case, the light source would be constituted by the optical image formation element. Such an optical image formation element creates an optical image by causing point light sources that correspond to picture elements to emit light for each of the picture elements, according to the image signal.

In the first and the second embodiments explained above, the structure is such that, when projecting an image to be projected that is of a rectangular shape, information about the contents to be projected and so on is appended and displayed in a blank margin portion, as shown in FIGS. 5(a) and 5(b). However, it would also be acceptable to arrange not to append this information in a blank margin portion, but to form the projected image so that the blank margin portion is black colored or grey colored so as to make it darker than the portion which consists of the contents to be projected. Moreover, it would also be acceptable to provide a structure in which the projected image is rotated so as to correspond to any desired attitude, i.e. not only to the ones shown in FIGS. 2(a) through 2(c).

The above explanation is only provided by way of example; it is not to be considered, in the interpretation of the invention, as limiting the correspondence relationship between structural elements of the above described embodiments and structural elements of the present invention in any way.

The present application is based upon Japanese Patent Application 2005-263661 that was filed on 12 Sep. 2005, and hereby incorporates its contents by reference.

1. A projecting apparatus, comprising:
a projection unit that projects an image formed by an optical image formation element;
an attitude detection device that detects an attitude of the projection unit, and outputs a detection signal; and
a rotation device that rotates a projected image that is projected from the projection unit, according to a detection signal from the attitude detection device.

2. A projecting apparatus according to claim 1, wherein:
the rotation device rotates an image to be formed by the optical image formation element according to the detection signal from the attitude detection device.

3. A projecting apparatus according to claim 1, wherein:
the rotation device rotates the optical image formation element according to the detection signal from the attitude detection device.

4. A projecting apparatus according to claim 1, further comprising:
an actuation member that is actuated in order to command rotation of the projected image; wherein:
the rotation device changes over between rotating the projected image, and not rotating the projected image, according to a command from the actuation member.

5. A projecting apparatus according to claim 2, wherein:
the optical image formation element has an effective picture element region of approximately square shape.

6. A projecting apparatus according to claim 5, wherein:
the optical image formation element makes a long side of an image of rectangular shape correspond to one side of the projected image, and generates an image by appending information in a blank margin that is formed in a short side direction of the image.

7. A projecting apparatus according to claim 5, wherein:
the optical image formation element is a liquid crystal panel.

8. A projecting apparatus according to Claim 5, wherein:
the projected image to be projected from the projection unit is projected at a same size, even after rotation by the rotation device.

9. A projecting apparatus according to claim 1, further comprising:
a first chassis that contains the projection unit;
a second chassis that is different from the first chassis; and
a rotation support member that rotatably supports the first chassis and the second chassis; wherein:
the projection unit projects in a plane that is orthogonal to a rotational axis of the rotation support member; and
the attitude detection device detects an attitude of the first chassis.

10. A projecting apparatus according to claim 9, wherein:
the attitude detection device detects a relative angle between the first chassis and the second chassis when the second chassis has been rotated relative to the first chassis, as the attitude of the first chassis; and
the rotation device causes the projected image to be rotated through a same angle as the relative angle.

11. A projecting apparatus according to claim 1, further comprising:
a control unit that controls a projection operation executed by the projection unit; and
a rotation support member that supports the projection unit and the control unit rotatably relative to one another; wherein:
the attitude detection device detects a relative angle of the projection unit with respect to the control unit.

12. A control method for a projecting apparatus comprising a projection unit that projects an image formed by an optical image formation element, comprising:
detecting an attitude of the projection unit; and
rotating the image projected through the projection unit according to the attitude of the projection unit that has been detected.
